(19) United States
(12) Patent Application Publication
(10) Pub. No.: US 2002/0068207 A1
(43) Pub. Date: Jun. 6, 2002

(54) High-temperature membrane fuel cell, method for operating an HTM fuel cell battery, and HTM fuel cell battery

(76) Inventors: Manfred Baldauf, Erlangen (DE); Ulrich Gebhardt, Langensendelbach (DE)

Correspondence Address: Werner H. Stemer, P.O. BOX 2480, Hollywood, FL, 33022-2480, US

(21) Appl. No.: 09/992,341

(22) Filed: Nov. 19, 2001

Related U.S. Application Data
(63) Continuation of application No. PCT/DE00/01502, filed on May 12, 2000.

(30) Foreign Application Priority Data
May 19, 1999 (DE) 199 22 922.8

(51) Int. Cl. H01M 8/04; H01M 8/12; H01M 4/94

(52) U.S. Cl. 429/26; 429/30; 429/44; 429/13

(57) ABSTRACT

A high-temperature membrane (HTM) fuel cell, a method for operating an HTM fuel cell, and an HTM fuel cell battery prevent the electrolyte from being washed out while the battery is starting by having the product water not condensing within the fuel cell unit and by heating the fuel cell unit, in a locally limited manner, to evaporate the product water.

### CROSS-REFERENCE TO RELATED APPLICATION

This application is a continuation of copending International Application No. PCT/DE00/01502, filed May 12, 2000, which designated the United States.

### BACKGROUND OF THE INVENTION

1. Field of the Invention

The invention relates to a high-temperature membrane (HTM) fuel cell, to a method for operating an HTM fuel cell, and to an HTM fuel cell battery.

The prior art includes polymer electrolyte membrane (PEM) fuel cell, which as its electrolyte has a base polymer to which [—SO₃H] groups are attached. In such a case, the electrolytic conduction takes place through hydrated protons. Accordingly, the membrane needs liquid water, i.e., under standard pressure requires operating temperatures of below 100° C., to ensure proton conductivity.

A starting point for eliminating the restriction on the operating temperature is that of using a different membrane (which may also be an ion exchange membrane) and/or a matrix with free and/or physically bonded and/or chemically bonded phosphoric acid as the electrolyte for a fuel cell instead of the membrane that contains [—SO₃H] groups. Such a fuel cell is referred to as a high-temperature membrane fuel cell, and is referred to below as an HTM fuel cell.

However, when producing an HTM fuel cell with free phosphoric acid, at least one problem arises, namely, that the electrolyte is washed out at temperatures below 100° C., i.e., when starting and/or shutting down the fuel cell installation. The washing results from the formation of product water on the cathode. Such formation condenses in the fuel cell unit and then enters the membrane as liquid water, where it dilutes the physically bonded electrolyte, such as, for example, the phosphoric acid, and ultimately washes it out. The problem occurs principally when the fuel cell is operated in start/stop mode, i.e., in mobile applications. The loss of electrolyte caused by the washing out of the electrolyte may lead to losses in performance or even to the cell failure. The electrolyte washed out on both sides of the membrane leaves the cell, for example, in the form of fine droplets, together with the process-gas stream. To keep the cell operational, electrolyte has to be topped up.

Such a problem exists with prior art phosphoric acid fuel cells PAFC, but is, in such a case, of subordinate importance because the PAFC is used predominantly in stationary, steady-state mode for a prolonged period, and most of the electrolyte loss takes place during the starting. The use of the invention for stationary systems, however, is obvious because, there, economic advantages are expected to be provided by the invention.

### SUMMARY OF THE INVENTION

It is accordingly an object of the invention to provide a high-temperature membrane fuel cell, a method for operating an HTM fuel cell battery, and a HTM fuel cell battery that overcomes the hereinafore-mentioned disadvantages of the heretofore-known devices and methods of this general type and that is able to function without having to top up the electrolyte.

With the foregoing and other objects in view, there is provided, in accordance with the invention, a high-temperature membrane fuel cell, including a membrane, electrodes including an anode and a cathode, each of the anode and the cathodes having an associated reaction gas chamber, and at least one of group consisting of the electrodes and the associated reaction gas chamber being at least locally heatable.

The invention relates to a high-temperature membrane fuel cell, having a membrane and two electrodes, the anode and the cathode, with associated reaction gas chambers. One or both of the electrodes and/or one or both reaction gas chambers are at least locally heatable.

With the objects of the invention in view, there is also provided a method for operating a high-temperature membrane fuel cell battery including the steps of providing a fuel cell stack of individual fuel cell units at a temperature of less than 100° C., and locally heating at least one of an electrode and a reaction gas chamber to a temperature at which product water formed is in a gas phase and leaves the fuel cell units in gas form.

In other words, at a temperature of the fuel cell stack of below 100° C., at least one electrode and/or one reaction gas chamber is locally heated so that the product water that forms does not condense, but, rather, leaves the fuel cell unit in gas form.

With the objects of the invention in view, there is also provided a high-temperature membrane fuel cell battery including at least one fuel cell unit with electrodes and associated reaction gas chambers and means for at least locally heating of at least one of the group consisting of individual ones of the electrodes and one of the associated reaction gas chambers of an individual fuel cell unit. In other words, the cathode and/or anode of the unit and/or one of the reaction gas chambers of the unit is heatable.

In accordance with another feature of the invention, at least one of the cathode and the reaction gas chamber of the cathode are locally heatable. However, corresponding measures may also be carried out on the anode side of fuel cells.

In accordance with a further feature of the invention, there is provided a heater element connected to at least one of the electrodes.

In accordance with an added feature of the invention, the heater element is a wire. Preferably, the wire is serpentine shaped, wound, and/or coiled.

In accordance with an additional feature of the invention, the heater element is a catalytic burner.

In accordance with yet another feature of the invention, there is provided a catalyst layer, a gas diffusion layer, and a terminal plate. The catalyst layer together with at least one of the electrodes, the gas diffusion layer and the terminal plate itself is a heater element

In accordance with yet a further feature of the invention, the heater element heats by current passing therethrough.

In accordance with yet an added feature of the invention, the heater element is only in portions of at least one of the electrodes, the terminal plate, and the gas diffusion layer to form heatable regions and non-heatable regions.

In accordance with yet an additional feature of the invention, at least one of the group consisting of a fuel cell unit and a separate battery supplies the heating means or device.

In accordance with again another feature of the invention, the heating means or device is formed by recombination of fuel gas and oxidizing agent.

In accordance with a concomitant mode of the invention, the locally heating step is performed by locally heating to a heating temperature greater than 100° C.

### DESCRIPTION OF THE PREFERRED EMBODIMENTS

The basis of the invention uses a conventional high-temperature membrane (HTM) fuel cell configured as an HT PEM fuel cell. Accordingly, there is no need for a description to be associated with reference to drawing figures.

An individual fuel cell unit includes a centrally disposed membrane with an electrode coating on both sides. The electrode coating includes a gas diffusion layer that, for example, has a current collector made from carbon fabric or the like, and a layer including the electrocatalyst, which directly adjoins the membrane. The fuel cell unit is enclosed respectively by one terminal plate at the top and the bottom. The terminal plate is also referred to as a cell plate or a bipolar plate.

A stack of individual fuel cell units, which is referred to in the specialist field as a fuel cell stack, includes at least one fuel cell with the associated end plates and supply lines, as well as a cooling system. It is also possible for the cooling system to have components that are disposed outside the stack.

A fuel cell battery includes at least one fuel cell stack and associated units that are also disposed in the battery, such as, for example, a reformer.

In such a fuel cell, the problem of the electrolyte being washed out when an HTM fuel cell installation is started is avoided by the fact that, in the fuel cell stack according to the invention, locally limited heating to temperatures of over 100° C. is carried out, so that the liquid product water, which would typically cause the undesired washing out in the membrane, is evaporated before it penetrates into the membrane. As a result, even at temperatures that lie below the operating temperature of the HTM fuel cell, conditions corresponding to those achieved when the operating temperature is reached are locally simulated. Therefore, identical conditions can be used even when the fuel cell is starting.

The locally limited regions in which the simulation takes place are, preferably, those regions in which the product water that forms would condense out without the temperature increase.

The local heating causes the product water to be formed in the form of vapor. The water in vapor form is discharged, for example, with a gas stream, in particular, with the process gas stream from the fuel cell.

For local heating, to evaporate the process water at starting temperatures of below 100° C., a heater element is required. According to a first configuration of the invention, the heater element may be at least one wire that is embedded, for example, in the catalyst layer of the electrode, in the gas diffusion layer, and/or in the terminal plate or the cell plate or the bipolar plate of the fuel cell unit. The wire is, for example, wound in serpentine form or in some similar form as a resistance wire. As a result, heat is generated when electric current passes through the resistor wire.

According to a second embodiment of the invention, the catalyst layer together with the electrode serves directly as the heater element, for example, in the form of a catalytic burner, fuel and oxidizing agent, i.e., O₂ and/or air, being passed alternately onto the catalyst layer. Such a catalytic burner leads to the so-called steady burning that heats the reaction gas chamber.

According to a third embodiment of the invention, the catalyst layer together with the electrode, the gas diffusion layer, and/or the terminal plate itself serves directly as the heater element, for example, as a result of current passing through it.

According to a modification of the third embodiment, the heater element is present only in parts of the electrode, of the terminal plate, and/or the gas diffusion layer so that they have heatable regions and non-heatable regions.

While the electrical power released by the fuel cell battery itself or by an external battery serves supply purposes in the exemplary embodiments with heating elements through which current flows, whereby an additional storage battery can be present, if necessary, in addition to the fuel cell unit, the heating in the other cases is effected directly by the conversion of the chemical energy that is present in the fuel. The recombination of fuel gas an oxidizing agents that leads to an exothermic process, are, thus, used.

Other features that are considered as characteristic for the invention are set forth in the appended claims.

Although the invention is illustrated and described herein as embodied in a high-temperature membrane fuel cell, a method for operating an HTM fuel cell battery, and a HTM fuel cell battery, it is, nevertheless, not intended to be limited to the details set forth because various modifications and structural changes may be made therein without departing from the spirit of the invention and within the scope and range of equivalents of the claims.

The construction and method of operation of the invention, however, together with additional objects and advantages thereof, will be best understood from the description of the preferred embodiments.

We claim:

1. A high-temperature membrane fuel cell, comprising:
a membrane;
electrodes including an anode and a cathode, each of said anode and said cathodes having an associated reaction gas chamber; and
at least one of group consisting of said electrodes and said associated reaction gas chamber being at least locally heatable.

2. The fuel cell according to claim 1, wherein at least one of said cathode and said reaction gas chamber of said cathode are locally heatable.

3. The fuel cell according to claim 1, including a heater element connected to at least one of said electrodes.

4. The fuel cell according to claim 3, wherein said heater element is a wire.

5. The fuel cell according to claim 4, wherein said wire is serpentine shaped.

6. The fuel cell according to claim 4, wherein said wire is wound.

7. The fuel cell according to claim 4, wherein said wire is coiled.

8. The fuel cell according to claim 3, wherein said heater element is a catalytic burner.

9. The fuel cell according to claim 3, including a catalyst layer, a gas diffusion layer, and a terminal plate, said catalyst layer together with at least one of said electrodes, said gas diffusion layer and said terminal plate itself is a heater element.

10. The fuel cell according to claim 9, where said heater element heats by current passing therethrough.

11. The fuel cell according to claim 9, wherein said heater element is only in portions of at least one of said electrodes, said terminal plate, and said gas diffusion layer to form heatable regions and non-heatable regions.

12. A method for operating a high-temperature membrane fuel cell battery, which comprises:
providing a fuel cell stack of individual fuel cell units at a temperature of less than 100° C.; and
locally heating at least one of an electrode and a reaction gas chamber to a temperature at which product water formed is in a gas phase and leaves the fuel cell units in gas form.

13. The method according to claim 12, which further comprises performing the locally heating step by locally heating to a heating temperature greater than 100° C.

14. A high-temperature membrane fuel cell battery, comprising:
at least one fuel cell unit with electrodes and associated reaction gas chambers; and
means for at least locally heating of at least one of the group consisting of individual ones of said electrodes and one of said associated reaction gas chambers of an individual fuel cell unit.

15. The HTM fuel cell battery according to claim 14, wherein at least one of the group consisting of a fuel cell unit and a separate battery supplies the heating means.

16. The HTM fuel cell battery according to claim 14, wherein said heating means is formed by recombination of fuel gas and oxidizing agent.

17. A high-temperature membrane fuel cell battery, comprising:
at least one fuel cell unit with electrodes and associated reaction gas chambers; and
a heater at least locally heating at least one of the group consisting of individual ones of said electrodes and one of said associated reaction gas chambers of an individual fuel cell unit.
